(19) United States
(12) Patent Application Publication
(10) Pub. No.: US 2005/0179523 A1
(43) Pub. Date: Aug. 18, 2005

(54) Dual sound coil structure for a sounder device

(76) Inventor: Chao-Ning Chiang, Taoyuan Hsien (TW)

Correspondence Address: Marquess Co., Ltd., P.O. Box No. 6-57, Junghe, Taipei, 235, TW

(21) Appl. No.: 10/777,115

(22) Filed: Feb. 13, 2004

(51) Int. Cl. G08B 3/00

(52) U.S. Cl. 340/388.1; 340/384.73

(57) ABSTRACT

A dual sound coil structure for a sounder device, which can be utilized in sounder devices including speakers, telephone receivers, buzzers, microphones, and so on. The present invention is primarily configured to include two sound coils fashioned within the one sounder device and which actualize integration with vibrating diaphragms, and further enables modification of impedance of the sound coils in accordance with usage requirements, thereby achieving objective of providing the sounder device with dual circuit functionality.

### BACKGROUND OF THE INVENTION

(a) Field of the Invention

The present invention relates to a dual sound coil structure for a sounder device, which can be utilized in speakers, telephone receivers, buzzers, microphones, and so on. The present invention more particularly relates to a configuration whereby two sound coils are fashioned within the one sounder device and which actualize integration with vibrating diaphragms, and further enables modification of impedance of the sound coils in accordance with usage requirements, moreover, achieves objective of providing the sounder device with dual circuit functionality.

(b) Description of the Prior Art

Accordingly, a conventional sounder device, for instance, a speaker, a telephone receiver, a buzzer, a microphone, and so on, are primarily assembled from a configuration including a magnet, a vibrating diaphragm and a sound coil, whereby an appropriate impedance is generated through an adjustable electrical resistance, and after an electric current flows, a sound is thus enabled to be produced. Referring to FIG. 1, which shows an assemblage of the conventional sounder device 10 comprising utilization of a vibrating diaphragm 11 configured at a frontal section of the sounder device 10, and a sound coil 13, wherewith upon the electric current flowing through an electrical connecting wire 14, a sound is thereby produced. Referring to FIG. 2, which shows a side cutaway view of the conventional sounder device 10, and as FIG. 2 depicts, the sounder device 10 comprises a supporting frame 18 and an iron U-shape 12, wherewith a seat member is formed therefrom. A space of a recess of the iron U-shape 12 provides for disposing a magnet 15 therein, and an electrode 16 is configured immediately atop the magnet 15. Furthermore, a terminal board 17 is configured at an appropriate section of a lower edge of an outer side of the supporting frame 14, therewith providing for an electrical connection with peripheral electronic devices. In addition, the sound coil 13 peripherally encircles the electrode 16 and the magnet 15, and a vibrating diaphragm 11 is configured atop the supporting frame 18. Upon an electric current flowing, sound is produced by means of different electrical impedances of the sound coil 13 actuating functionality of the vibrating diaphragm 11.

However, the conventional sounder device 10 as described above is unable to accommodate practical demands of present electronic devices, for instance, taking current mobile phones as an example, upon receiving a signal from an incoming telephone call, the electrical impedance required for phonation of a telephone ring is approximately 8 ohms, and after the telephone call is put through to a receiver, the phonation of the telephone receiver then requires approximately 32 ohms, Accordingly, the telephone ring requires 8 ohms, and upon pressing a key to accept the incoming telephone call or opening up a cover of the mobile phone switches off 8 ohms, thereat the incoming telephone call is put through, and the telephone receiver thereupon requires 32 ohms. If the aforementioned conventional sounder device 10 is utilized as a sound provider device, then two of the sounder devices 10 are required, one sounder device providing electrical impedance of 8 ohms, and another sounder device providing electrical impedance of 32 ohms. Referring to FIGS. 3a and 3b, which show configurations for the conventional sounder device 10 depicting a general juxtaposition configuration (see FIG. 3a) and a superposition configuration (see FIG. 3b). With such configurations, space required for layout of the mobile phone is certainly increased in order to accommodate the two sounder devices 10, which thus produces a product that not only does not conform to present product design principles for miniaturization and refinement, moreover, cost of installing the two sounder devices 10 will be high.

### SUMMARY OF THE INVENTION

In light of the aforesaid shortcomings, the present invention provides an appropriately improved configuration for a structure of a sounder device. A primary objective being to provide the sounder device that is capable of producing two sounds from different electrical impedances which respectively function within the one sounder device, and thereby significantly reduce space required for layout of the sounder device, and substantially lower material costs.

A dual sound coil structure for a sounder device of the present invention can be utilized in sounder devices including speakers, telephone receivers, buzzers, microphones, and so on, and is primarily configured to include two sound coils fashioned within the one sounder device and which actualize integration with vibrating diaphragms, and further enables modification of impedance of the sound coils in accordance with usage requirements, thereby achieving objective of providing the sounder device with dual circuit functionality.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a general elevational view of a conventional sounder device.

FIG. 2 shows a side cutaway view of the conventional sounder device.

FIG. 3a shows a schematic view of a configuration of a conventional sounder device.

FIG. 3b shows a schematic view of a configuration of another conventional sounder devices.

FIG. 4 shows a side cutaway view according to the present invention.

FIG. 5 shows a top view of a preferred embodiment according to the present invention.

FIG. 6 shows a top view of another preferred embodiment according to the present invention.

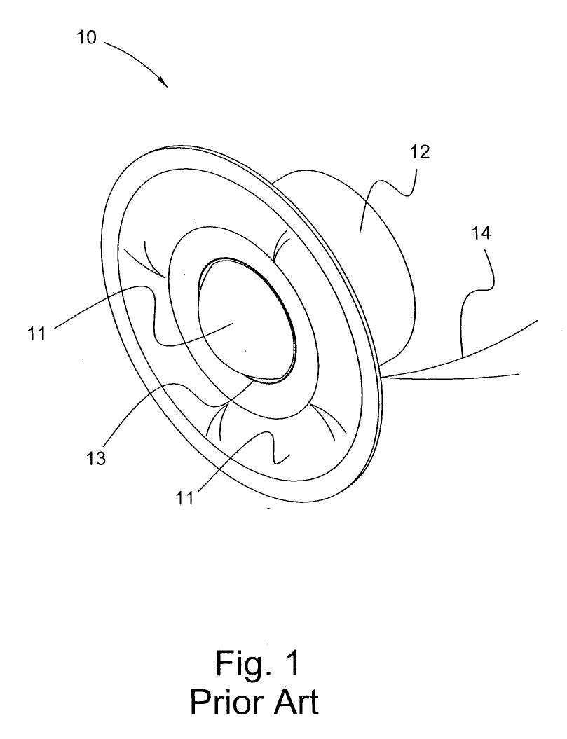

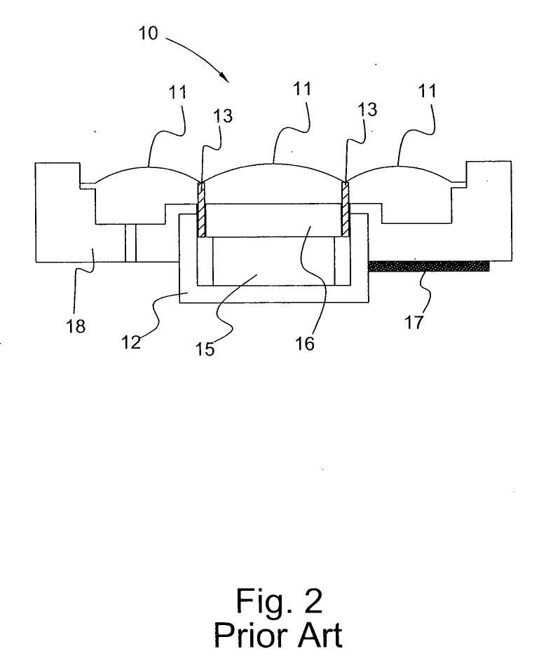

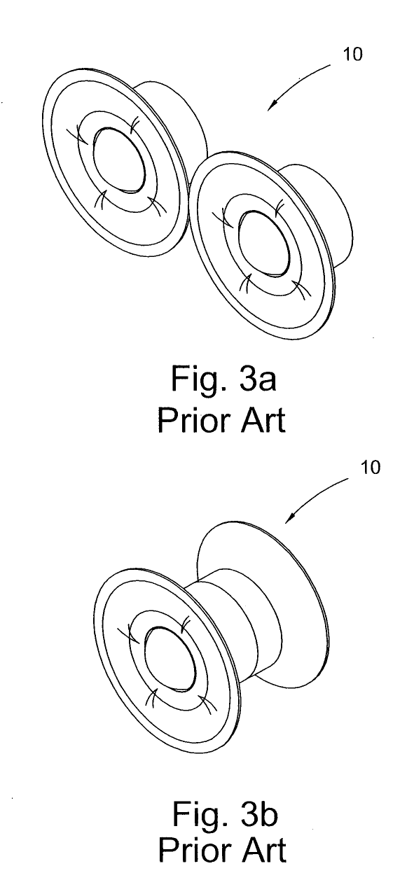

### DETAILED DESCRIPTION OF THE PREFERRED EMBODIMENTS

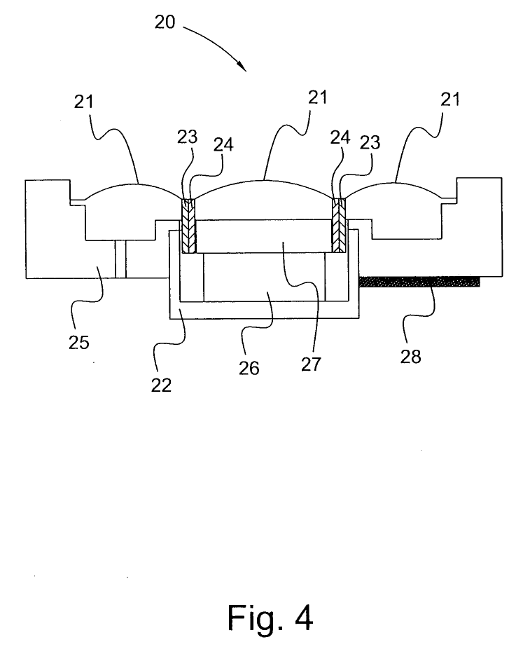

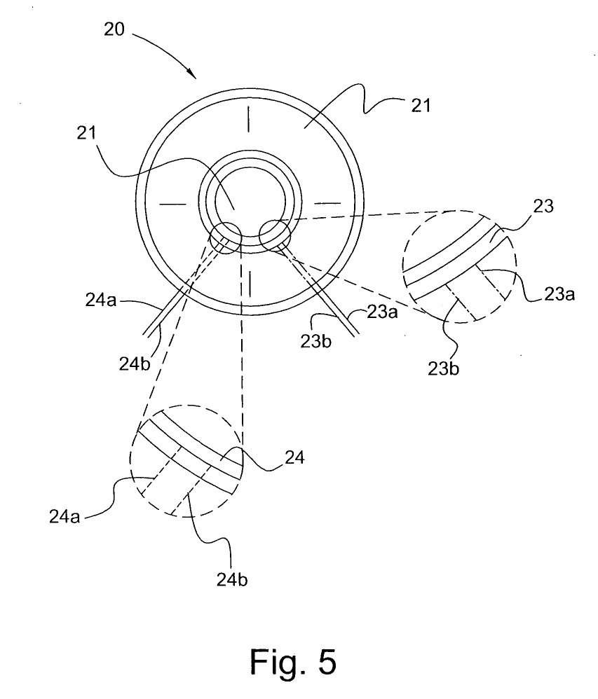

Referring to FIG. 4, which shows a dual sound coil structure for a sounder device of the present invention. The sounder device 20 comprises a supporting frame 25 and an iron U-shape 22; therewith a seat member is formed therefrom. A space of a recess of the iron U-shape 22 provides for disposing a magnet 26 therein, and an electrode 27 is configured immediately atop the magnet 26. Furthermore, a terminal board 28 is configured at an appropriate section of a lower edge of an outer side of the supporting frame 25, therewith providing for an electrical connection with peripheral electronic devices. In addition, a first sound coil 23 peripherally encircles the electrode 27 and the magnet 26, and another second sound coil 24 peripherally encircles the first sound coil 23. Vibrating diaphragms 21 are configured atop the supporting frame 25. Furthermore, the first sound coil 23 and the second sound coil 24 are attached to the vibrating diaphragms 21. Thus, according to the aforementioned sounder device 20, the two sound coils (namely the first sound coil 23 and the second sound coil 24) are configured within one assemblage of structural members, and upon an electric current flowing, sound of two different frequencies is produced by means of two different electrical impedances of the first sound coil 23 and the second sound coil 24 respectively successively actuating functionality of the vibrating diaphragms 2. FIG. 5 depicts a preferred embodiment of the present invention, whereby a parallel electrical connection configuration is employed, wherein an electrical connecting wire 23a and an electrical connecting wire 23b connect to the first sound coil 23 (see right side of FIG. 5), and an electrical connecting wire 24a and an electrical connecting wire 24b connect to the second sound coil 24, and the electrical impedance of the first sound coil 23 is 8 ohms, and the electrical impedance of the second sound coil 24 is 32 ohms. Taking a mobile phone as an example, when receiving a signal from an incoming telephone call, the first sound coil 23 is actuated (having electrical impedance of 8 ohms) and thereby enables production of a telephone ring. Upon pressing a key to accept the incoming call or lifting a cover of the mobile phone, thereat the electric current is transferred to the electrical connecting wire 24a, and the second sound coil 24 is immediately actuated (having electrical impedance of 32 ohms) and implements functionality to accept the incoming telephone call. When the incoming telephone call has been put through, the first sound coil 23 thereupon halts functioning. In addition, the electrical impedance of the first sound coil 23 and the second sound coil 24 can be adjusted in accordance with usage requirements.

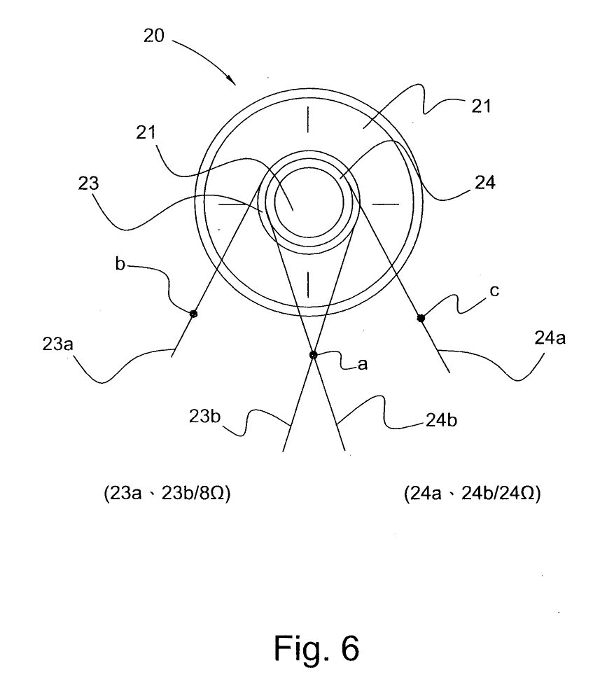

Referring to FIG. 6, which shows another preferred embodiment of the dual sound coil structure for a sounder device of the present invention, whereby a series electrical connection configuration is employed, wherein the electrical connecting wire 23a and the electrical connecting wire 23b connect to the first sound coil 23, and the electrical connecting wire 24a and the electrical connecting wire 24b connect to the second sound coil 24. In addition, the electrical connecting wire 23b and the electrical connecting wire 24b mutually join at a connecting point a, and the electrical impedance of the first sound coil 23 is 8 ohms, and the electrical impedance of the second sound coil 24 is 24 ohms. Taking the mobile phone as an example, upon receiving a signal from an incoming telephone call the first sound coil 23 is actuated to provide the electrical impedance of 8 ohms required for the telephone ring (two points a and b), and when the mobile phone is in state of readiness to receive the incoming call the first sound coil 23 and the second sound coil 24 function in series to generate the electrical impedance of 32 ohms (points b and c functioning in series to generate 24 ohms+8 ohms=32 ohms). Accordingly, upon accepting the incoming telephone call, the telephone receiver requires the electrical impedance of 32 ohms to function, and upon the electric current flowing through the electrical connecting wires 23b and 24b, thereat the points b and c of the first sound coil 23 and the second sound coil 24 respectively are actuated to function in series. In addition, the electrical impedance of the first sound coil 23 and the second sound coil 24 can be modulated in accordance with usage requirements.

According to the aforementioned disclosures, the dual sound coil structure for a sounder device of the present invention comprises two sound coils 23 and 24 configured in the one sounder device 20, whereby the two sound coils 23 and 24 are enabled to utilize the same sounder device 20 to successively achieve effectiveness of generating two sounds by means of the parallel connection or the series connection. Because of requirement of only one sounder device 20, such configurations thereby realize significant reduction in space required for layout of the mobile phone, while achieving effectiveness of respectively producing two sounds. Furthermore, the above-disclosed configurations can dispense with material costs for the additional sounder device. The dual sound coil structure for a sounder device of the present invention thus provides at least the following advantages:

1. Requirement of only one sounder device 20 comprising the two sound coils 23 and 24 having different electrical impedances and disposed in juxtaposition, thus providing the sounder device 20 with functionality to produce two variant sounds.

2. Economization on space required for layout of the sounder device 20, thereby enabling miniaturization and refinement of electronic devices.

3. Economization on cost of materials, thereby enhancing price competitiveness.

In conclusion, the dual sound coil structure for a sounder device of the present invention, based on trial implementation, assuredly accomplishes objectives of producing two sounds from variant electrical impedance while only requiring the one sounder device 20, thereby significantly reducing space required for the layout of the sounder device 20, and significantly lowering material costs.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A dual sound coil structure for a sounder device comprising:
a seat member configured from an iron U-shape and a supporting frame;
a magnet disposed within the iron U-shape, and an electrode is configured atop the magnet;
a terminal board configured on an outer side of the supporting frame, with which provides for an electrical connection;
a first sound coil, which peripherally encircles the electrode and the magnet, moreover, a pair of electrode leading wires outwardly extend therefrom, and provide for an electrical connection therewith;
a second sound coil, which peripherally encircles the first sound coil, moreover, a pair of electrode leading wires outwardly extend therefrom, and provide for an electrical connection therewith; and
vibrating diaphragms configured atop the supporting frame, and upon fitting the vibrating diaphragms, the first sound coil and the second sound coil are thereby joined to the vibrating diaphragms.

2. The dual sound coil structure for a sounder device according to claim 1, wherein a series connection is competed between the first sound coil and the second sound coil.

3. The dual sound coil structure for a sounder device according to claim 1, wherein a parallel connection is competed between the first sound coil and the second sound coil.

4. The dual sound coil structure for a sounder device according to claim 1, wherein impedance of the first sound coil can be modified in accordance with requirements.

5. The dual sound coil structure for a sounder device according to claim 1, wherein impedance of the second sound coil can be modified in accordance with requirements.
